(19) United States
(12) Patent Application Publication
(10) Pub. No.: US 2006/0106618 A1
(43) Pub. Date: May 18, 2006

(54) System and method for converting text to speech

(75) Inventors: Dean Anthony Racovolis, Redmond, WA (US); Steven Harris Mitchell, Tumwater, WA (US)

Correspondence Address: Daniel P. McLoughlin;Wolf, Greenfield & Sacks, P.C., 600 Atlantic Avenue, Boston, MA, 02210-2206, US

(73) Assignee: Microsoft Corporation, Redmond, WA (US)

(21) Appl. No.: 10/977,777

(22) Filed: Oct. 29, 2004

(51) Int. Cl. G10L 11/00

(52) U.S. Cl. 704/277

(57) ABSTRACT

Text is converted to speech based at least in part on the context of the text. A body of text may be parsed before being converted to speech. Each portion may be analyzed to determine whether it has one or more particular attributes, which may be indicative of context. The conversion of each text portion to speech may be controlled based on these attributes, for example, by setting one or more conversion parameter values for the text portion. The text portions and the associated conversion parameter values may be sent to a text-to-speech engine to perform the conversion to speech, and the generated speech may be stored as an audio file. Audio markers may be placed at one or more locations within the audio file, and these markers may be used to listen to, navigate and/or edit the audio file, for example, using a portable audio device.

### BACKGROUND

There are a variety of text-to-speech engines (TSEs) on the market today that convert text to speech, for example, on a computer. Typically these TSEs are invoked by an application running on a computer. The application invokes the TSE by utilizing programming hooks in a standard Speech Application Programming Interface (SAPI) to make programming calls into the SAPI. The TSE converts the text to speech and plays the speech to a user over the computer's speakers. For example, some systems enable users to listen to their email messages by playing the messages as speech, and in some cases, playing the speech over the user's phone which has access to the user's email server on a network.

Most people do not find it pleasant to listen to the speech rendered by most TSEs. The text-converted speech is often described as sounding like a robot. Some TSEs are more sophisticated and render a more human-sounding voice. However, even these TSEs are difficult to listen to after a while. This is because TSEs are configured to recognize the syntax of text, but not the context of the text. That is, TSEs are configured to recognize the grammar, structure and content of text, and apply predefined conversion rules based on this recognition, but do not take into account whether the sentence is part of a heading, is in bold or italics font, or in all capital letters, or is proceeded by bullet points, etc. Accordingly, the text is converted the same way every time, regardless of its context. After a while, a listener gets bored listening to text converted in this manner, and the speech begins to sound redundant.

### SUMMARY

Described herein are systems and methods for converting text to speech based at least in part on the context of the text. A body of text may be parsed before being converted into speech. The text may be parsed into portions such as, for example, sections, chapters, pages, paragraphs, sentences and/or fragments thereof (e.g., based on punctuation and other rules of grammar),words or characters. Each portion may be analyzed to determine whether it has one or more particular attributes, which may be indicative of context (e.g., the linguistic context). For example, it may be determined whether the text portion is indented, is preceded by a bullet point, is italicized, is in bold font, is underlined, is double-underlined, is a subscript, is a superscript, lacks certain punctuation, includes certain punctuation, has a particular font size in comparison to other font sizes in the text, is in all upper case, is in title case, is justified in a certain way (e.g., right, center, left or full), is at least part of a heading, is at least part of a header or footer, is at least part of a table of contents (TOC), is at least part of a footnote, has other attributes, or has any combination of the foregoing attributes. The conversion of the text portion to speech may be controlled based on these attributes, for example, by setting one or more conversion parameter values for the portion. For a given text portion, values may be set for any of the following conversion parameters: volume, cadence speed, voice accent, voice fluctuation, syllable emphasis, pausing before and/or after the portion, other parameters, and any suitable combination thereof. Values may be set for any of these parameters and sent to a text-to-speech engine (TSE) along with the given text portion. For example, a programming call may be made to a standard Speech API (SAPI) for each text portion, including set values for certain SAPI parameters.

The text may be selected by a user, and may be an entire digital document such as, for example, a word processing (e.g., Microsoft® Word) document, a spreadsheet (e.g., Excel™) document, a presentation (e.g., PowerPoint®) document, an email (e.g., Outlook®) message, or another type of document. Alternatively, the text may be a portion of a document such as, for example, a portion of any of the foregoing.

The resulting speech may be sent to an audio playing device to play the speech (e.g., using one or more speakers) and/or may be saved as an audio file (e.g., a compressed audio file) on a recording medium. Further, the conversion process may involve including audio markers in the speech (e.g., between one or more portions). As used herein, an “audio marker” is an indication in an audio file of a boundary between portions of content of the audio file. Such an audio marker may be used, for example, to parse the audio file, navigate the audio file, remove one or more portions of the audio file, reorder one or more portions and/or insert additional content into the audio file. For example, the audio markers may be included in the generated speech, which may be saved as an audio file on a portable audio device. As used herein, a “portable audio device” is a device constructed and arranged for portable use and capable of playing sound, such as, for example, a portable media player (PMP), a personal digital assistant (PDA), a cellphone, a dictaphone, or another type of portable audio device.

A user may listen to the generated speech on a portable audio device, which may be configured to enable the user to navigate and edit the speech, for example, using audio markers in the speech. After editing, the speech may be converted back into text that includes the edits made by the user while the text was in speech form.

Creating and editing audio files from text in the manner described above enables users to listen to and edit documents and other literature while simultaneously performing other activities such as, for example, exercising and running errands. Further, users can use their ears and voice, as opposed to their eyes, hands and wrists (which tend to tire faster), to listen to and edit content. For people with certain disabilities, such a system and method may enable such persons to experience and edit content that they would otherwise not be able to experience and edit.

A system enabling such context-based speech-to-text conversion may include a conversion controller to control the conversion as described above. The controller may be configured to control a TSE, for example, by making programming calls into the SAPI serving as an interface to the TSE. Further, the conversion controller may be configured to control a compression engine to compress the speech into a compressed audio file, such as, for example, an MP3 (MPEG Audio Layer-3) file or WMA (Windows Media Audio) file. Alternatively, the conversion controller may not use a compression engine so that the speech remains uncompressed, for example, as a WAV file.

The conversion controller may be configurable by a programmer and/or the system may include a user interface enabling a user to configure one or more aspects of the conversion. For example, the user interface may enable a user to configure the type of portions into which the text is parsed, attributes of the portions to be analyzed, and conversion parameter values to be set based on the analysis of the attributes.

In one embodiment of the invention, a conversion of text to speech is controlled. A body of digital text is received, and parsed into a plurality of portions. For each portion, it is determined whether the portion has one or more particular attributes, and, if the portion has one or more of the particular attributes, one or more conversion parameter values of the portion are set. A conversion of the plurality of portions from digital text to speech is controlled. For at least each portion for which a conversion parameter value was set, the conversion of the portion is based at least in part on the one or more conversion parameter values set for the portion.

In an aspect of this embodiment, controlling the conversion includes sending the plurality of portions to a text-to-speech engine for conversion to speech, including, for at least each portion for which a conversion parameter value was set, sending the one or more conversion parameter values of the portion.

In another aspect of this embodiment, the speech is stored as an audio file, which may be compressed.

In another aspect of this embodiment, the one or more particular attributes of each portion are indicative of a context of the portion.

In another aspect of this embodiment, the speech is sent to an audio-playing device.

In other aspects of this embodiment, the body of text is parsed into a plurality of one of the following: sections, chapters, pages, paragraphs, sentences, at least sentence fragments (e.g., based on punctuation), words or characters, such that each of the plurality of portions is a section, chapter, page, paragraph, sentence, at least a sentence fragment, word or character, respectively.

In yet another aspect of this embodiment, for each portion, it is determined whether the portion has certain formatting and/or organizational attributes.

In another aspect of this embodiment, the body of digital text is only a portion of a digital document.

In another aspect of this embodiment, the conversion is controlled so that the speech includes an audio marker at one or more locations.

In various aspects of this embodiment, a user interface is provided that enables a user to do one or more of the following: specify one or more attributes to analyze for each of the plurality of portions; specify a type of the plurality of portions into which to parse the body of digital text; specify one or more conversion parameter values corresponding to one or more respective attributes; or specify one or more locations at which to place audio markers.

In another embodiment of the invention, a computer-readable medium is provided that stores computer-readable signals defining instructions that, as a result of being executed by a computer, instruct the computer to perform the embodiment of the invention described in the preceding paragraphs and/or one or more aspects thereof described in the preceding paragraphs.

In another embodiment, a system for controlling a conversion of text to speech is provided. The system comprises a conversion controller to receive a body of digital text and parse the body of digital text into a plurality of portions. The conversion controller is also operative to determine, for each portion, whether the portion has one or more particular attributes, and to set, for each portion having the one or more of the particular attributes, one or more conversion parameter values of the portion. The conversion controller is also operative to control a conversion of the plurality of portions from digital text to speech, including, for at least each portion for which a conversion parameter value was set, basing the conversion of the portion at least in part on the one or more conversion parameter values set for the portion.

In an aspect of this embodiment, the conversion controller is further operative to send the plurality of portions to a text-to-speech engine for conversion to speech, including, for at least each portion for which a conversion parameter value was set, sending the one or more conversion parameter values of the portion.

In another aspect of this embodiment, the conversion controller is further operative to control storing the speech as an audio file, which may be a compressed audio file.

In another aspect of this embodiment, the one or more particular attributes of each portion are indicative of a context of the portion.

In yet another aspect of this embodiment, the conversion controller is further operative to control sending the speech to an audio-playing device.

In other aspects of this embodiment, the conversion controller is further operative to parse the body of text into a plurality of one of the following: sections, chapters, pages, paragraphs, sentences, at least sentence fragments (e.g., based on punctuation), words or characters, such that each of the plurality of portions is a section, chapter, page, paragraph, sentence, at least a sentence fragment, word or character, respectively.

In another aspect of this embodiment, the conversion controller is further operative to determine, for each portion, whether the portion has certain formatting and/or organizational attributes.

In another aspect of this embodiment, the body of digital text is only a portion of a digital document.

In another aspect of this embodiment, the conversion controller is further operative to control the conversion so that an audio marker is included at one or more locations within the speech.

In yet another aspect of this embodiment, the system further comprises a user interface to enable a user to do one or more of the following: specify one or more attributes to analyze for each of the plurality of portions; specify a type of the plurality of portions into which to parse the body of digital text; specify one or more conversion parameter values corresponding to one or more respective attributes; or specify one or more locations at which to place audio markers.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1 is a diagram illustrating an embodiment of a system for converting text to speech in an audio file and editing the audio file in accordance some embodiments of the invention;

FIG. 2 is a block and data flow diagram illustrating an example of a system for converting text to speech in accordance with some embodiments of the invention;

FIG. 3 is a block and data flow diagram illustrating an example of the function of a parsing engine in accordance with some embodiments of the invention;

FIG. 4 is a flow chart illustrating an example of a method of converting text to speech according to some embodiments of the invention;

FIG. 5 is a diagram illustrating an example of a portable audio device for playing, navigating and editing an audio file in accordance with some embodiments of the invention;

FIG. 6 is a block and data flow diagram illustrating an example of a system for playing, navigating and editing an audio file in accordance with some embodiments of the invention;

FIG. 7 is a block diagram illustrating an example of a computer system on which some embodiments of the invention may be implemented; and

FIG. 8 is a block diagram illustrating an example of a stored system that may be used as part of the computer system to implement some embodiments of the invention.

### DETAILED DESCRIPTION

Now will be described systems and methods for converting text to speech based at least in part on the context of the text. Although these systems and methods are described primarily in relation to saving the generated speech in an audio file, the invention is not so limited. Alternatively, or in addition to saving the generated speech as an audio file, the generated speech may be sent to an audio playing device, which controls the playing of the speech on the, for example, over one or more speakers.

The function and advantage of these and other embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition, Revision 2, May 2004), Section 2111.03.

### EXAMPLES

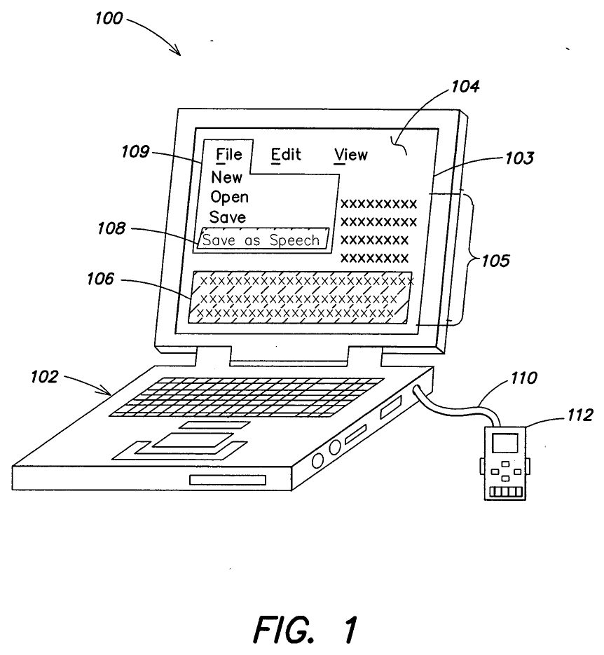

FIG. 1 is a diagram illustrating an embodiment of a system 100 for converting text to speech in an audio file and editing the audio file in accordance some embodiments of the invention. System 100 is merely an illustrative embodiment of such a system, intended to provide context for various embodiments of the invention. Any of numerous other implementations of such a system, for example, variations of system 100, are possible, and are intended to fall within the scope of the invention. For example, although FIG. 1 illustrates a notebook or laptop computer, it should be appreciated that other types of computers may be used, for example, a desktop PC or workstation. Further, the system may be implemented on a single device such as, for example, computer 102, portable audio device 112, or another type of device.

System 100 may include any of a computer 102 and a portable audio device 112, which may be connected by connection 110 such as, for example, a Universal Serial Bus (USB), or any suitable type of connection, including an optical or wireless connection. The computer 102 may include a display screen 103 capable of displaying a user interface display 104 (e.g., a Graphical User Interface (GUI) display) controlled by a user interface (e.g., a GUI) as part of the execution of an application (e.g., Microsoft® Word). The user interface display may display written text 105. As used herein, a “user interface” is an application or part of an application (i.e., a set of computer-readable instructions) that enables a user to interface with an application during execution of the application. A user interface may include code defining how an application outputs information to a user during execution of the application, for example, visually through a computer screen or other means, audibly through a speaker of other means, and manually through a game controller or other means. Such user interface also may include code defining how a user may input information during execution of the application, for example, audibly using a microphone or manually using a keyboard, mouse, game controller, track ball, touch screen or other means.

The user interface may define how information is visually presented (i.e., displayed) to the user, and defines how the user can navigate the visual presentation (i.e., display) of information and input information in the context of the visual presentation. During execution of the application, the user interface may control the visual presentation of information and enable the user to navigate the visual presentation and enter information in the context of the visual presentation. Types of user interfaces range from command-driven interfaces, where users type commands, menu-driven interfaces, where users select information from menus, and combinations thereof, to GUIs, which typically take more advantage of a computer's graphics capabilities, are more flexible, intuitive and easy to navigate and have a more appealing “look-and-feel” than command-driven and menu-driven visual user interfaces.

As used herein, the visual presentation of information presented by a user interface or GUI is referred to as a “user interface display” or a “GUI display”, respectively.

The user interface providing the display 104 may be configured to enable a user to select a digital document or a portion thereof, for example, portion 106, and to enable the user to specify converting the selected text to speech (i.e., save as speech), for example, by selecting menu entry 108 from the file menu 109. The body of text 106 then may be converted to speech and saved as an audio file. The audio file may be downloaded to portable audio device 112, on which the audio file may be played, navigated, edited and returned to computer 102 over network segment 110, as described in more detail below.

Although not shown in FIG. 1, menu 109, or another part of user interface display 104, may provide a user the option of playing selected text as speech, in addition, or as an alternative, to saving it as an audio file. If a user selects this option, the selected text may be played as speech by computer 102 or a periphery device of the computer. Further, it should be appreciated that audio files generated from text are not limited to being played by portable audio player 112, but may be played using one or more applications residing on computer 102. Moreover, it should be appreciated that any functionality described herein as being resident on a computer may be resident on a suitably constructed and configured portable audio device and vice versa.

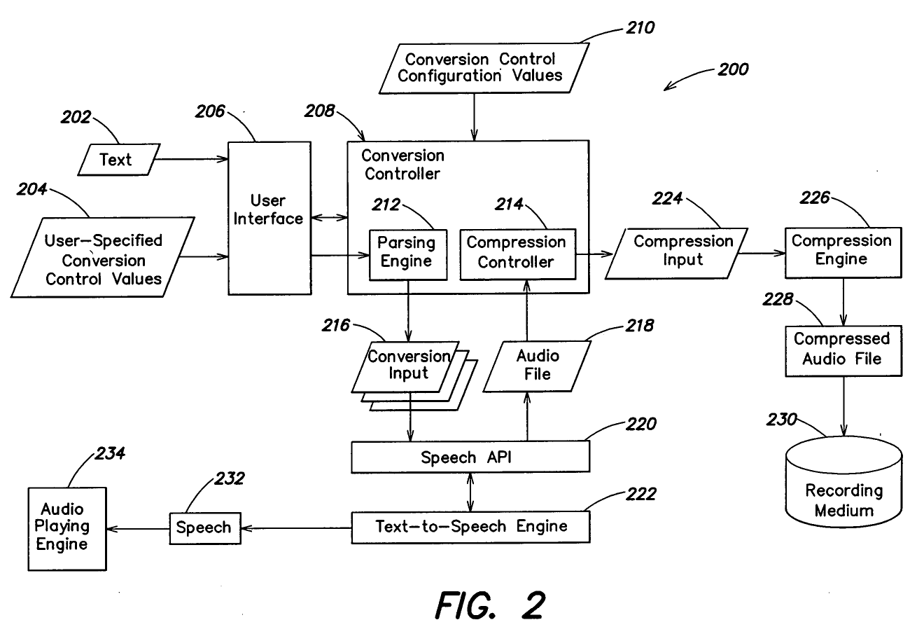

FIG. 2 is a block and data flow diagram illustrating an example of a system 200 for converting text-to-speech in accordance with some embodiments of the invention. System 200 is merely an illustrative embodiment of such a system, and is not intended to limit the scope of the invention. Any of numerous other implementations of such a system, for example, variations of system 200, are possible and are intended to fall within the scope of the invention.

System 200 may include any of user interface 206, conversion controller 208, SAPI 220, SPE 222, compression engine 226, recording medium 230 and other components. As used herein, an “application programming interface” or “API” is a set of one or more computer-readable instructions that provide access to one or more other sets of computer-readable instructions that define functions, so that such functions can be configured to be executed on a computer in conjunction with an application program. An API may be considered the “glue” between application programs and a particular computer environment or platform (e.g., any of those discussed below) and may enable a programmer to program applications to run on one or more particular computer platforms or in one or more particular computer environments.

Conversion controller 208 may be configured to control a conversion of text to speech based at least in part on the context of the speech, and may include any of parsing engine 212 and compression controller 214. Conversion controller 208 may be configured to receive text 202, and possibly user-specified conversion control values 204, and to control the generation of speech based thereon. The behavior of conversion controller 208 may be configured using conversion control configuration values 210, for example, by a programmer, prior to receiving any text. For example, configuration values 210 may control the default behavior of the conversion controller, as is described in more detail below. This default behavior may be overridable by one or more of the user-specified values 204.

Parsing engine 212 may be configured to parse a body of text 212 to produce conversion inputs 216, which may be sent to TSE 222 through SAPI 220. Parsing engine 212 may be configured to parse text 202 into any of a plurality of types of portions, for example, sections, chapters, pages, paragraphs, sentences and/or fragments thereof (e.g., based on punctuation and other rules of grammar), words, characters or other types of portions. For example, configuration values 210 may set the default type of the portions into which parsing engine 212 will parse text. This type may be overridable by a user-specified type included in user-specified conversion control values 204. As used herein, “plurality” means two or more.

It should be appreciated that the parsing engine 212, and the conversion controller 208 in general, may be configured (e.g., with configuration values 210 and/or user specified values 204) to utilize information provided by the application from which the text is selected. For example, many applications maintain information indicating the boundaries between sections, chapters, pages, paragraphs, sentences, sentence fragments, words and/or characters in a document. Conversion controller 208 and components thereof may be configured to utilize this information to parse and analyze text, as is described in more detail below. For example, in a Word document, Word may divide the body of text into special “paragraphs” and normal “paragraphs.” It should be appreciated that Word “paragraphs” do not necessarily correlate to a paragraph in the grammatical sense. For example, Word may define a heading as a special type of paragraph, as opposed to a normal paragraph. Parsing engine 212 may be configured to utilize this information and parse a body of Word text into Word paragraphs.

Parsing engine 212 may be configured to parse text in a finer fashion. For example, parsing engine may be configured to parse text by identifying periods in the text, or may be configured to parse text based on punctuation such as, for example, commas, semicolons, colons, periods and hyphens. In this configuration, the text may be divided into sentences and sentence fragments, depending on the punctuation within a sentence. Further, the parsing engine 212 may be configured to parse text into words.

Parsing engine 212 may be configured to analyze each portion parsed from the text, for example, to determine whether the portion has one or more particular attributes (e.g., formatting and/or organizational attributes). Such attributes may be indicative of a context of a portion, and therefore may be used to alter the manner in which the text is converted to speech to reflect this context. For example, the parsing engine 212 may be configured to determine whether a portion of text has any of the following attributes: is indented, is preceded by a bullet point, is italicized, is in bold font, is underlined, is double-underlined, is a subscript, is a superscript, lacks certain punctuation, includes certain punctuation, has a particular font size in comparison to other font sizes in the text, is in all upper case, is in title case, is justified in a certain way (e.g., right, center, left or full), is at least part of a heading, is at least part of a header or footer, is at least part of a TOC, is at least part of a footnote, has other attributes, or has any combination of the foregoing attributes. The parsing engine may be configured to determine other attributes of a text portion based on one or more of these attributes. For example, parsing engine 212 may be configured to determine that a portion of text is a heading if the portion of text has a combination of one or more of the following attributes: does not end with a period, is center-justified, is in all uppercase, is in title case, is underlined or is in bold font.

The parsing engine may be configured to set one or more conversion parameter values of a portion, for example, based on one or more determined attributes of the portion. Setting these one or more conversion parameter values may control TSE 222 to convert the text portion to speech based on the context of the text, which may make the text sound more like actual human speech and add emphasis to important portions of the text. Further, human-sounding speech typically is more pleasurable to a listener than robot-like speech. For example, TSE 222 may be configurable with any of a variety of conversion parameter values for controlling the conversion of text that it receives. These conversion parameters may include any of: volume, cadence speed, voice accent, voice fluctuation, syllable emphasis, pausing before and/or after the text, other conversion parameters and any suitable combination thereof. The parsing engine 212 may be configured to set values for any of these conversion parameters through the speech API 220.

For example, if the parsing engine 212 determines that a text portion is heading, the parsing engine 212 may set conversion parameter values that result in an increased volume (e.g., 2%) and a reduced cadence speed (5%) of the generated speech and a pause (0.2 seconds) before and after the generated speech.

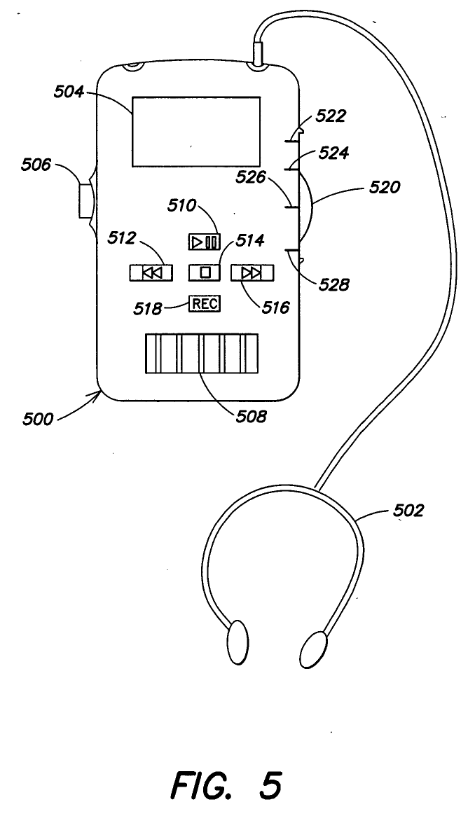

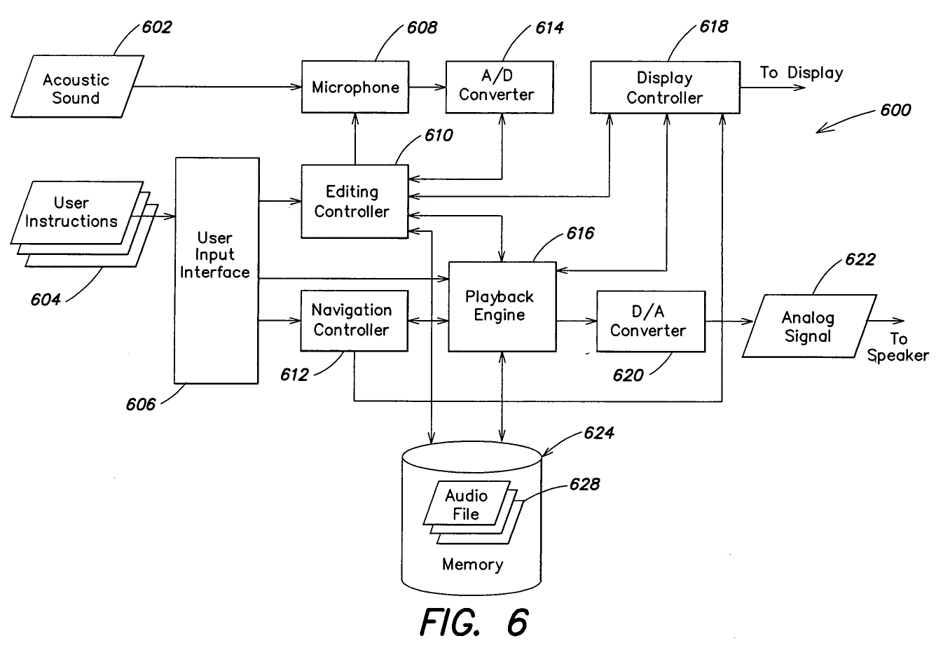

The parsing engine 212 may be configured (e.g., by values 212 and/or values 204) to include audio markers at one or more locations within the speech to be generated. For example, it may be desirable to include audio markers in between each of the portions into which the text is parsed. Alternatively, the audio markers may be placed at less than all of these locations and/or at other locations. Some TSEs have the capability of inserting such marks (often referred to as “bookmarks”) into speech that they generate. The parsing engine 212 may be configured to utilize this capability of a TSE by setting the proper conversion parameter values. These audio markers then may be used at a later time to navigate and edit the content of an audio file in which the generated speech is stored, for example, as is described below in more detail in relation to FIGS. 5 and 6.

The user interface 206 may be configured to enable the user to provide the user-specified conversion control values 204, for example, by providing a user interface display enabling a user to select and/or enter values. Such a user interface display may include menus, drop boxes, radio buttons, text boxes, combo boxes or any of a variety of other types of controls that enable a user to enter and/or select values.

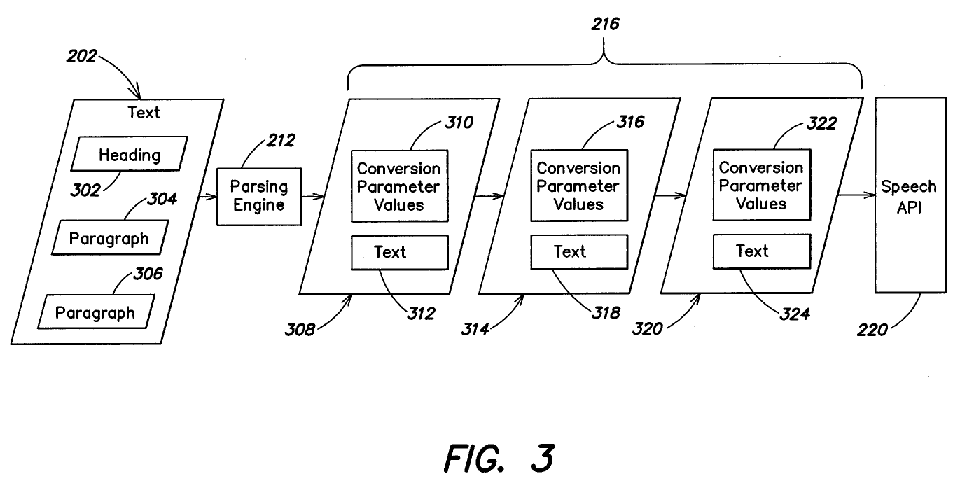

Digressing briefly from FIG. 2, FIG. 3 is a block and data flow diagram illustrating an example of the parsing function of the parsing engine 212 in accordance with some embodiments of the invention. The parsing engine 212 may receive text 202, including a heading 302 and paragraphs 304 and 306. Based on configured conversion control values 210 and user-specified conversion control values 204, the parsing engine 212 may parse text 202 into text portions, analyze attributes of the text portions, set one or more conversion parameter values, and generate conversion inputs 216. Conversion inputs 216 may include inputs 308, 314 and 320, corresponding to paragraph 306, paragraph 304 and heading 302, respectively. Each conversion input 308 may include the text portion to be converted, and conversion parameter values provided by parsing engine 212. For example, conversion input 308 may include text portion 312 corresponding to paragraph 306 and conversion parameter values 310; conversion input 314 may include text portion 318 corresponding to paragraph 304 and conversion parameter values 316; and text portion 320 may include text 324 corresponding to heading 302 and conversion parameter values 322. The text portions 216 may be sent to the speech API 220 in the order in which they are to be converted to speech.

Parsing engine 212 or another component of conversion controller 208 may be configured to notify the speech API (e.g., in one of the text portions that is sent to the speech API or in a different communication) when the converting of a body of text begins and ends. In an embodiment where the generated speech is saved in an audio file, the speech API 220 may use the beginning and end notifications to open a new audio file and to close the audio file, respectively. In this manner, the conversion controller may control the creation of a single audio file from the body of text, even though multiple conversion inputs are sent to the TSE for the single body of text.

Returning to FIG. 2, in response to receiving text portions 216, SPE 222 may produce audio file 218 (e.g., uncompressed), which may be sent to compression controller 214 through SAPI 220. The conversion controller 214 may be configured to send the audio file 218 along with compression instructions as compression input 224 to compression engine 226 (e.g., Windows Media® Encoder). Compression engine 226 then may compress the audio file into compressed audio file 228, which may be stored on a recording medium 230.

The conversion controller 208 may be configured to control the TSE 22 to send the generated speech 232 to an audio playing engine 234, in addition to or as an alternative to generating audio file 218. The audio playing engine 234 may be configured to immediately play the speech in response to receiving it. Thus, a body of text may be converted to speech and played immediately and/or stored as an audio file for later use.

System 200, and components thereof may be implemented using software (e.g., C, C#, C++, Java, or a combination thereof), hardware (e.g., one or more application-specific integrated circuits), firmware (e.g., electrically-programmed memory) or any combination thereof. One or more of the components of system 200 may reside on a single device (e.g., a computer), or one or more components may reside on separate, discrete devices. Further, each component may be distributed across multiple devices, and one or more of the devices may be interconnected.

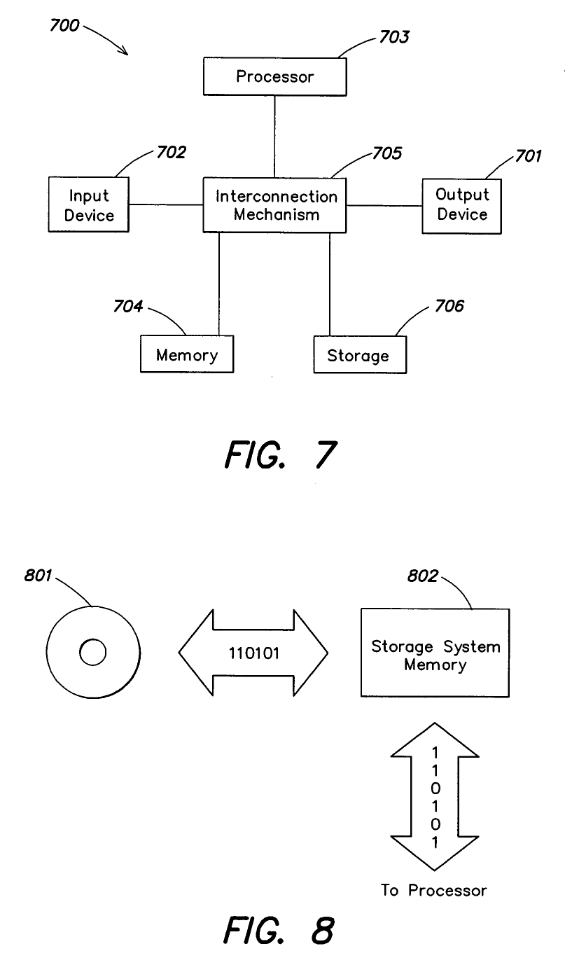

Further, on each of the one or more devices that include one or more components of system 200, each of the components may reside in one or more locations on the system. For example, different portions of the components of system 200 may reside in different areas of memory (e.g., RAM, ROM, disk, etc.) on the device. Each of such one or more devices may include, among other components, a plurality of known components such as one or more processors, a memory system, a disk storage system, one or more network interfaces, and one or more busses or other internal communication links interconnecting the various components. System 200 and components thereof may be implemented using a computer system such as that described below in relation to FIGS. 7 and 8.

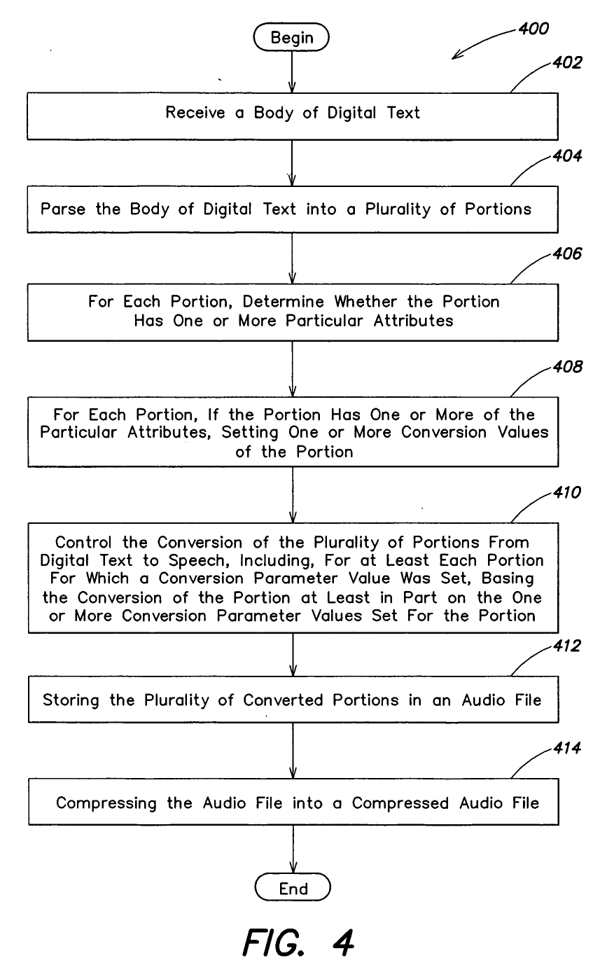

FIG. 4 is a flowchart illustrating an example of a method 400 of converting text to speech in accordance with some embodiments of the invention. Method 400 is merely an illustrative embodiment of a method of converting text to speech and is not intended to limit the scope of the invention. Any of numerous other implementations of such a method, for example, variations of method 400, are possible and are intended to fall within the scope of the invention. Method 400 may include additional acts. Further, the order of the acts performed as part of method 400 is not limited to the order illustrated in FIG. 4, as the acts may be performed in other orders and/or one or more of the acts may be performed in series or in parallel (at least partially).

In Act 402, a body of digital text (e.g., text represented in digital form) is received. This body of digital text may be a digital document (e.g., any type of document described above) or a portion thereof.

In Act 404, the body of the digital text may be parsed into a plurality of portions, for example, as described above in relation to the parsing engine 212 of system 200. The body of text may be parsed based on parsing values with which parsing engine (e.g. engine 212) is configured and/or based on one or more parsing values provided by a user.

In Act 406, it may be determined, for each portion, whether the portion has one or more particular attributes (e.g., formatting and/or organizational attributes), such as, for example, any of the attributes described above in relation to FIG. 2). These attributes may be determined by a parsing engine such as parsing engine 212 described above, based on one or more values with which the parsing engine is configured or which are provided by a user.

In Act 408, for each portion, one or more conversion parameters of the portion may be set if the portion has one or more of the particular attributes determined in Act 406. The conversion parameter values may be set by a parsing engine (e.g., engine 212) based on one or more values with which the parsing engine is configured and/or one or more conversion parameter values provided by a user, as described above in relation to system 200.

In some embodiments, converting the text to speech may include inserting an audio marker at one or more locations within the generated speech (not shown), for example, as described in relation to FIG. 2. The locations at which these audio markers are placed may be based on configured values and/or user-specified values.

In Act 410, the conversion of the plurality of portions generated in Act 404 from digital text to speech may be controlled, for example, by a conversion controller (e.g. conversion controller 208) as described above in relation to FIGS. 2 and 3. Controlling this conversion may include, for at least each portion for which a conversion parameter value is set, basing the conversion of the portion at least in part on the one or more conversion parameter values set for the portion. For example, controlling the conversion may include sending the plurality of portions and the conversion parameter values associated with these portion to an SPE (e.g. SPE 222) through a SAPI (e.g. SAPI 220), as described above in relation to FIGS. 2 and 3.

In some embodiments, the conversion of the plurality of portions may include generating an audio file, and storing the plurality of converted portions (e.g., the speech) in the audio file (Act 412), and compressing the audio file to a compressed audio file (Act 414). For example, the TSE may generate an audio file (e.g. uncompressed), which may be sent along with compression instructions to a compression engine, which may generate the compressed audio file. In some embodiments, as an alternative or in addition to generating an audio file, the generated speech may be sent to an audio playing engine that may play the speech as audio, for example on one or more speakers.

Method 400 acts thereof and various embodiments and variations of these methods and acts, individually or in combination, may be defined by computer-readable signals tangibly embodied on or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein (e.g., method 400 or any acts thereof), and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable media on which such instructions are embodied may reside on one or more of the components of any of systems 100, 200, 300, 500, 600, 700, or 800 described herein, may be distributed across one or more of such components, and may be in transition therebetween.

The computer-readable media may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described in relation to FIGS. 2, 3 and 6, that perform the functions described herein can be generically considered as one or more controllers that control such functions. The one or more controllers can be implemented in numerous ways, such as with dedicated hardware and/or firmware, using a processor that is programmed using microcode or software to perform the functions recited above or any suitable combination of the foregoing.

The speech generated from method 400 and/or the system 200 described above (e.g., based on the context of the text from which the speech was generated) may be more pleasurable to a listener than speech resulting from known text-to-speech generation. Accordingly, users are less likely to get bored listening to such generated text and may be more apt to listen to and edit content in audio form as opposed to text form. Further, because listening and editing audio files (described in more detail below) can be done simultaneously with other activities, for example, through use of a portable media player, workers and students can do work without interfering with these activities. As a result, workers and student may become more productive.

Having now described embodiments of systems and methods for converting text to speech, some embodiments of listening to, navigating and/or editing generated speech in an audio file will now be described. Although these embodiments are described primarily in relation to listening to, navigating and/or editing an audio file on a portable audio device, it should be appreciated that the invention is not so limited, as the audio files may be listened to, navigated and/or edited on any of a variety of types of devices such as, for example, a desktop computer.

FIG. 5 is a diagram illustrating an example of a portable audio player 500 and headset 502 for listening to, navigating and/or editing an audio file. Player 500 (with or without headset 502) may be used to listen to, navigate and/or edit an audio file including speech converted from text, such as, for example, speech generated by system 200 and/or according to method 400.

The portable audio device may be any of a variety of types of devices such as, for example, a PMP, a PDA, a cell phone, a dictaphone, another type of device, or any suitable combination of the foregoing. Portable audio device 500 may include any of display window 504, record button 506, microphone 508, pause/play button 510, skip-back button 512, stop button 514, skip-forward button 516, record button 518, and control slider 520. Slider 520 may be slidable to any of a plurality of positions, for example, a skip-forward position 522, a play position 524, a stop position 526 and a skip-back position 528. Thus, control slider 520 and record button 506 may provide control that is redundant to that provided by buttons 512-518, and may enable the user to use the portable audio device with only one hand, whereas it would be more difficult to do so using only buttons 512-518. Device 500 also may include one or more speakers (not shown) in addition or as an alternative to headset 502.

Play/pause button 510 may enable a user to play a current portion of audio, for example, a song or a portion of speech, and to pause same. Skip back button 512 and skip forward button 516 are navigational controls that may enable a user to navigate audio content stored on the portable audio device. For example, these buttons may enable a user to navigate to a next or previous song or portion of text marked by an audio marker. Device 500 may include additional navigation controls, for example, a fast forward and a rewind control. Further, skip controls may be configured to provide additional functionality if a user holds down one of these control buttons or presses it twice in fast succession.

Record buttons 506 and 518 may enable a user to initiate recording new audio content (e.g., speech) into an existing audio file, as is described below in more detail below. The user then may speak into microphone 508 to begin recording.

FIG. 6 is a block diagram illustrating an example of a system for playing, navigating and editing an audio file on a portable audio device. System 600 is merely an illustrative embodiment of such a system, and is not intended to limit the scope of the invention. Any of numerous other implementations of such a system, for example, variations of system 600, are possible and are intended to fall within the scope of the invention. System 600 may be used to listen to, navigate and/or edit an audio file including speech converted from text, such as, for example, speech generated by system 200 and/or according to method 400.

System 600 may be housed within a portable audio device (e.g., device 500), and may include any of user interface 606, microphone 608, analog-to-digital (A/D) converter 614, display controller 618, editing controller 610, navigation controller 612, play back engine 616, digital-to-analog (D/A) converter 620, memory 624 and other components. User input interface 606 may be configured to receive user instructions, for example, play back instructions, navigational instructions and recording instructions, from a user of a portable audio device. The user interface then may pass these instructions to the appropriate device. For example, playback instructions may be sent to playback engine 616, navigational instructions may be sent to navigational controller 612 and editing instruction may be sent to editing controller 610.

In response to user instructions and communications exchanged with the editing controller and the navigation controller, playback engine 616 may access one or more audio files 628 and when appropriate, control the playback of these audio files by sending digital audio information to D/A converter 620. D/A converter 620 may generate an analog signal 622 that it sends to a speaker. In response to an editing instruction, for example, a recording instruction, the editing controller 610 may control a microphone to receive acoustic sound 602 (e.g., the voice of a user) and control the conversion of the acoustic sounds to digital audio by the AID converter 614 and an audio encoder (not shown). The editing controller 610 further may be enabled to access an audio file 628 from memory 624 in response to a recording instruction, and insert the digital audio generated from the acoustic sound into the audio file at the appropriate location.

For example, using navigational controls 512 and 516 or control slider 520 at position 522 or 528, a user may utilize audio markers to move to the location within an audio file (marked by an audio marker) at which the user wishes to insert speech. The user then may press record button 506 or 518 which is received by a user instruction 604 by user input interface 606, which may send this instruction to editing controller 610. Editing controller 610 may control microphone 608, A/D converter 614 and the audio encoder to sense and encode any acoustic sound 602 provided by the user. The editing control may be configured to separate the audio file at the location indicated by the audio marker to which the user moved, and insert the encoded sound at the audio marker.

The editing control then may store the edited audio file back in memory 624 from which the playback engine 616 may play the edited audio file in response to instructions from a user. Display controller 618 may be configured to communicate with the editing controller 610, navigation controller 612 and playback engine 616, to display information to display 504 in accordance with the state of information being displayed, which may be affected by playback, navigation and editing instructions received from the user.

System 600, and components thereof may be implemented using software (e.g., C, C#, C++, Java, or a combination thereof), hardware (e.g., one or more application-specific integrated circuits), firmware (e.g., electrically-programmed memory) or any combination thereof. One or more of the components of system 600 may reside on a single device (e.g., a portable audio device), or one or more components may reside on separate, discrete devices. Further, each component may be distributed across multiple devices, and one or more of the devices may be interconnected.

Further, on each of the one or more devices that include one or more components of system 600, each of the components may reside in one or more locations on the system. For example, different portions of the components of system 600 may reside in different areas of memory (e.g., RAM, ROM, disk, etc.) on the device. Each of such one or more devices may include, among other components, a plurality of known components such as one or more processors, a memory system, a disk storage system, one or more network interfaces, and one or more busses or other internal communication links interconnecting the various components. System 600 and components thereof may be implemented using a computer system such as that described below in relation to FIGS. 7 and 8.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to convert text to speech and/or edit speech on a portable audio device according to various embodiments of the invention. Further, the software design system may be located on a single computer or may be distributed among a plurality of computers attached by a communications network.

A general-purpose computer system according to one embodiment of the invention is configured to perform convert text to speech and/or edit speech on a portable audio device. It should be appreciated that the system may perform other functions and the invention is not limited to having any particular function or set of functions.

For example, various aspects of the invention may be implemented as specialized software executing in a general-purpose computer system 700 such as that shown in FIG. 7. The computer system 700 may include a processor 703 connected to one or more memory devices 704, such as a disk drive, memory, or other device for storing data. Memory 704 is typically used for storing programs and data during operation of the computer system 700. Components of computer system 700 may be coupled by an interconnection mechanism 705, which may include one or more busses (e.g., between components that are integrated within a same machine) and/or a network (e.g., between components that reside on separate discrete machines). The interconnection mechanism 705 enables communications (e.g., data, instructions) to be exchanged between system components of system 700. Computer system 700 also includes one or more input devices 702, for example, a keyboard, mouse, trackball, microphone, touch screen, and one or more output devices 701, for example, a printing device, display screen, speaker. In addition, computer system 700 may contain one or more interfaces (not shown) that connect computer system 700 to a communication network (in addition or as an alternative to the interconnection mechanism AOS.

The storage system 706, shown in greater detail in FIG. 8, typically includes a computer readable and writeable nonvolatile recording medium 801 in which signals are stored that define a program to be executed by the processor or information stored on or in the medium 801 to be processed by the program. The medium may, for example, be a disk or flash memory. Typically, in operation, the processor causes data to be read from the nonvolatile recording medium 801 into another memory 802 that allows for faster access to the information by the processor than does the medium 801. This memory 802 is typically a volatile, random access memory such as a dynamic random access memory (DRAM) or static memory (SRAM). It may be located in storage system 706, as shown, or in memory system 704, not shown. The processor 703 generally manipulates the data within the integrated circuit memory 704, 802 and then copies the data to the medium 801 after processing is completed. A variety of mechanisms are known for managing data movement between the medium 801 and the integrated circuit memory element 704, 802, and the invention is not limited thereto. The invention is not limited to a particular memory system 704 or storage system 706.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 700 is shown by way of example as one type of computer system upon which various aspects of the invention may be practiced, it should be appreciated that aspects of the invention are not limited to being implemented on the computer system as shown in FIG. 7. Various aspects of the invention may be practiced on one or more computers having a different architecture or components that that shown in FIG. 7.

Computer system 700 may be a general-purpose computer system that is programmable using a high-level computer programming language. Computer system 700 may be also implemented using specially programmed, special purpose hardware. In computer system 700, processor 703 is typically a commercially available processor such as the well-known Pentium class processor available from the Intel Corporation. Many other processors are available. Such a processor usually executes an operating system which may be, for example, the Windows® 95, Windows® 98, Windows NT®, Windows® 2000 (Windows® ME) or Windows®XP operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of controlling a conversion of text to speech, the method comprising acts of:
(A) receiving a body of digital text;
(B) parsing the body of digital text into a plurality of portions;
(C) for each portion, determining whether the portion has one or more particular attributes;
(D) for each portion, if the portion has one or more of the particular attributes, setting one or more conversion parameter values of the portion; and
(E) controlling a conversion of the plurality of portions from digital text to speech, including, for at least each portion for which a conversion parameter value was set, basing the conversion of the portion at least in part on the one or more conversion parameter values set for the portion.

2. The method of claim 1, wherein the act (E) comprises sending the plurality of portions to a text-to-speech engine for conversion to speech, including, for at least each portion for which a conversion parameter value was set, sending the one or more conversion parameter values of the portion.

3. The method of claim 1, further comprising:
(F) storing the speech as an audio file.

4. The method of claim 1, further comprising:
(F) sending the speech to an audio-playing device.

5. The method of claim 1, wherein the one or more particular attributes of each portion are indicative of a context of the portion.

6. The method of claim 1, wherein the act (B) comprises parsing the body of text into a plurality of words such that each of the plurality of portions is a word.

7. The method of claim 1, wherein the act (B) comprises parsing the body of text based on punctuation, such that each of the plurality of portions is at least a fragment of a sentence.

8. The method of claim 1, wherein the act (B) comprises parsing the body of text into a plurality of sentences such that each of the plurality of portions is a sentence.

9. The method of claim 1, wherein the act (B) comprises parsing the body of text into a plurality of paragraphs such that each of the plurality of portions is a paragraph.

10. The method of claim 1, wherein the act (B) comprises, for each portion, determining whether the portion has certain formatting and/or organizational attributes.

11. The method of claim 1, wherein the body of digital text is only a portion of a digital document.

12. The method of claim 1, further comprising:
(F) controlling the conversion so that an audio marker is included at one or more locations within the speech.

13. The method of claim 1, wherein the method further comprising:
(F) providing a user interface that enables a user to specify one or more attributes to analyze for each of the plurality of portions.

14. The method of claim 1, further comprising:
(F) providing a user interface that enables a user to specify a type of the plurality of portions into which to parse the body of digital text.

15. The method of claim 1, further comprising:
(F) providing a user interface that enables a user to specify one or more conversion parameter values corresponding to one or more respective attributes.

16. The method of claim 1, further comprising:
(F) providing a user interface that enables a user to specify one or more locations at which to place audio markers.

17. A system for controlling a conversion of text to speech, the system comprising:
a conversion controller to receive a body of digital text, parse the body of digital text into a plurality of portions, determine, for each portion, whether the portion has one or more particular attributes, set, for each portion having the one or more of the particular attributes, one or more conversion parameter values of the portion, and control a conversion of the plurality of portions from digital text to speech, including, for at least each portion for which a conversion parameter value was set, basing the conversion of the portion at least in part on the one or more conversion parameter values set for the portion.

18. The system of claim 17, wherein the conversion controller is further operative to send the plurality of portions to a text-to-speech engine for conversion to speech, including, for at least each portion for which a conversion parameter value was set, sending the one or more conversion parameter values of the portion.

19. The system of claim 17, wherein the conversion controller is further operative to control storing the speech as an audio file.

20. The system of claim 17, wherein the one or more particular attributes of each portion are indicative of a context of the portion.

21. The system of claim 17, wherein the conversion controller is further operative to control sending the speech to an audio-playing device.

22. The system of claim 17, wherein the conversion controller is further operative to parse the body of text into a plurality of words such that each of the plurality of portions is a word.

23. The system of claim 17, wherein the conversion controller is further operative to parse the body of text based on punctuation, such that each of the plurality of portions is at least a fragment of a sentence.

24. The system of claim 17, wherein the conversion controller is further operative to parse the body of text into a plurality of sentences such that each of the plurality of portions is a sentence.

25. The system of claim 17, wherein the conversion controller is further operative to parse the body of text into a plurality of paragraphs such that each of the plurality of portions is a paragraph.

26. The system of claim 17, wherein the conversion controller is further operative to determine, for each portion, whether the portion has certain formatting and/or organizational attributes.

27. The system of claim 17, wherein the body of digital text is only a portion of a digital document.

28. The system of claim 17, wherein the conversion controller is further operative to control the conversion so that an audio marker is included at one or more locations within the speech.

29. The system of claim 17, wherein the system further comprises:
a user interface to enable a user to specify one or more attributes to analyze for each of the plurality of portions.

30. The system of claim 17, wherein the system further comprises:
a user interface to enable a user to specify a type of the plurality of portions into which to parse the body of digital text.

31. The system of claim 17, wherein the system further comprises:
a user interface to enable a user to specify one or more conversion parameter values corresponding to one or more respective attributes.

32. The system of claim 17, wherein the system further comprises:
a user interface to enable a user to specify one or more locations at which to place audio markers.

33. A computer-readable medium having computer-readable signals stored thereon that define instructions that, as a result of being executed by a computer, control the computer to perform a process of controlling a conversion of text to speech, the process comprising acts of:
(A) receiving a body of digital text;
(B) parsing the body of digital text into a plurality of portions;
(C) for each portion, determining whether the portion has one or more particular attributes;
(D) for each portion, if the portion has one or more of the particular attributes, setting one or more conversion parameter values of the portion; and
(E) controlling a conversion of the plurality of portions from digital text to speech, including, for at least each portion for which a conversion parameter value was set, basing the conversion of the portion at least in part on the one or more conversion parameter values set for the portion.

34. The computer-readable medium of claim 33, wherein the act (E) comprises sending the plurality of portions to a text-to-speech engine for conversion to speech, including, for at least each portion for which a conversion parameter value was set, sending the one or more conversion parameter values of the portion.

35. The computer-readable medium of claim 33, wherein the process further comprises:
(F) storing the speech as an audio file.

36. The computer-readable medium of claim 33, wherein the one or more particular attributes of each portion are indicative of a context of the portion.

37. The computer-readable medium of claim 33, wherein the act (B) comprises, for each portion, determining whether the portion has certain formatting and/or organizational attributes.

38. The computer-readable medium of claim 33, wherein the process further comprises:
(F) controlling the conversion so that an audio marker is included at one or more locations within the speech.

39. The computer-readable medium of claim 33, wherein the process further comprises:
(F) providing a user interface that enables a user to specify one or more attributes to analyze for each of the plurality of portions.

40. The computer-readable medium of claim 33, wherein the process further comprises:
(F) providing a user interface that enables a user to specify one or more conversion parameter values corresponding to one or more respective attributes and/or specify a type of the plurality portions of into which to parse the body of digital text.
